(19) United States
(12) Patent Application Publication
(10) Pub. No.: US 2026/0370774 A1
(43) Pub. Date: Nov. 19, 2026

(54) LED DISPLAY HAVING INTEGRATED OPTICAL DATA CAPTURING ELEMENTS FOR VIDEO VOLUME PRODUCTION ENVIRONMENTS

(71) Applicant: VU TECHNOLOGIES CORP., TAMPA, FL (US)

(72) Inventor: Timothy Kenneth Moore, Lutz, FL (US)

(21) Appl. No.: 19/392,077

(22) Filed: Nov. 17, 2025

Related U.S. Application Data
(63) Continuation-in-part of application No. 18/439,366, filed on Feb. 12, 2024, now Pat. No. 12,477,073.
Application No. 18/439,366 is a continuation of application No. 17/572,014, filed on Jan. 10, 2022, now Pat. No. 11,902,691.
(60) Provisional application No. 63/136,058, filed on Jan. 11, 2021.

(51) Int. Cl. H04N 5/222; G01S 17/66; G02B 5/12; G06F 3/14; H04N 23/50

(52) U.S. Cl. CPC H04N 5/2224; G01S 17/66; G02B 5/12; G06F 3/1446; H04N 23/50

(57) ABSTRACT

A LED panel wherein a plurality thereof are employed to construct a LED volume for filing simulated virtual environments, with each such panel having a display screen that includes an array of light-emitting pixels (e.g., LED, micro-LED, mini-LED, OLED, QD-LED) mounted on a substrate and an imaging subsystem operative to capture optical data from a scene in front of the display screen. The imaging subsystem may be optically and/or electrically integrated with the panel such that the surface of the LED panel simultaneously functions as both an emission surface and an aperture plane for image sensors of the imaging subsystem.

### CROSS REFERENCE TO RELATED APPLICATIONS

This application claims the benefit of and incorporates by reference co-pending U.S. nonprovisional patent application Ser. No. 18/439,366, filed on Feb. 12, 2024, which itself claimed the benefit of U.S. nonprovisional patent application Ser. No. 17/572,014, filed on Jan. 10, 2022 (now U.S. Pat. No. 11,902,691), which itself claimed the benefit of U.S. provisional patent application Ser. No. 63/136,058, filed on Jan. 11, 2021.

### BACKGROUND OF THE INVENTION

### Field of the Invention

The present invention relates generally to LED panel based virtual environments for film production, and more specifically, to an LED panel for use in virtual film environments which has integrated optical elements suitable to capture optical data from a scene in front of the panel.

### Description of the Prior Art

The video industry commonly employs the utilization of LED walls to simulate virtual environments wherein the LED walls produce a photorealistic image on camera. These simulated virtual environments produce an image that appears real on camera and are a cost effective alternative to location based shooting. Utilization of these virtual environments allows a real time rendering of backgrounds and is a significant improvement to conventional green screen technology which requires the background to be removed and rendered in post-production. The utilization of LED wall environments is referred to as virtual production or in camera visual effects. These LED walls are often constructed in studios and referred to as LED volumes when built in the shape of a dome.

The LED volumes are composed of a multitude of LED wall panels and LED ceiling panels so as to simulate a full three hundred and sixty degree environment of a virtual location. This technique offers advantages over traditional green screen video techniques by providing improved simulated lighting and reflections that are nearly indistinguishable from live shots in these environments which results in more accurate final images. By way of example but not limitation, a vehicle filmed on a green screen has complex reflections of green that appear in the mirrors, contours and windows and additionally has contamination of green ambient light thereon. Whereas an LED volume portrays a real time background through the windows and mirrors resulting in the reflection of the correct ambient light colors and visuals on the car in real time. This creates a level of realism that is far superior to the green screen scenes, which have to be manually created and manipulated in post-production.

For the illusion to work, the main camera within the LED volume must be tracked for position so that the environment can move appropriately to the perspective of the camera. This provides a forced perspective to create the illusion that the shot was filmed from a particular point of view that is a matching point of view of the objects such as but not limited to props on the stage. For example, when filming a car on a virtual road, the angle of the film capture should change perspectives in real time on the LED display from one lane to another when the camera is laterally moved from one lane to the other. For proper execution of the aforementioned, the camera's location in three-dimensional space must be tracked wherein the positional data is updated in a computer so that the proper perspective is displayed on the screen. This positional feedback loop that is created by using camera tracking is one of the most unique and important features to make virtual production appear real.

Currently there are two optical tracking methodologies or techniques that are commonly used for tracking the camera's position. The first is referred to as outside-in tracking and the second is referred to as inside-out tracking. In outside-in tracking, tracking devices are placed in stationary locations surrounding a marker on the tracked camera to determine its position in space by cross-referencing the position of the marker relative to the position of the tracking devices. These types of systems typically have multiple tracking devices that allow for a 360 degree perspective of the tracking marker on the tracked camera, and this overlap allows for accurate readings of the camera's position. The second existing methodology, inside-out tracking is the alternate methodology in which the tracking emitter is placed directly on the camera and looks outward to determine its location using markers within the room. These markers, often referred to as tracking stars, are signal reflectors used to triangulate the tracking emitters location in three-dimensional space. Often times a star constellation of tracking stars is created so as to increase the amount of tracking points, wherein hundreds of randomized reflective tracking markers are placed on the wall or ceiling to determine the camera's position in three-dimensional space.

The problem with the aforementioned existing technologies is inside the LED volume both of these methodologies rely on visible tracking elements that are often times visible in the final scene. The outside in camera tracking spoils the effect by appearing as a ring of tracking devices in the final footage and the inside out methodology show up as spotty artifacts where the star constellation markers occlude the virtual image on the LED screen. Ultimately, both of these methodologies require editors to remove these tracking devices or markers in post-production, which results in decreased workflow efficiency and increased cost. The goal of virtual production is to avoid the post-production process by recording real time virtual environments in camera and avoid having to remove tracking devices or tracking markers that are visible in the film but this cannot be accomplished with existing technology.

Accordingly, there is a need for a LED panel which can be utilized to create a LED volume for virtual film environments and which includes integrated optical data capturing elements, such as optical cameras, which are arranged so as to capture optical data from a scene in front of the display without compromising the display functionality of the panel.

### SUMMARY OF THE INVENTION

The present disclosure relates to an LED panel utilized to construct a LED volume for filming simulated virtual environments wherein the LED panel comprising: a housing having a frame, wherein said frame defines a perimeter edge for said housing; a display screen having a plurality of pixels disposed individually in a plurality of pixel capsules, wherein said display screen is mounted within said housing and being operable to display virtual images; a plurality of optical cameras integral with said display screen, wherein each of said optical cameras is positioned between at least one adjacent pixel capsule which is among the plurality of pixel capsules; and wherein the LED panel is operable to provide at least one technique of object tracking within the LED volume.

It is the object of the present invention to provide a LED panel utilized to construct LED volumes wherein the LED panel is operable to provide positional tracking of at least one camera wherein the LED panel of the present invention is housed in a cabinet.

Another object of the present invention is to provide a LED volume constructed from a plurality of LED panels that provide an ability to allow filming of real time virtual environments and three dimensional tracking of at least one camera and eliminate post-production requirements wherein the present invention employs embedding a plurality of retroreflectors into the LED panels wherein the retroreflectors are non-visible markers utilized to provide camera and/or object tracking.

A further object of the present invention is to provide a LED panel utilized to construct LED volumes wherein the LED panel is operable to provide positional tracking of at least one camera wherein at distances of more than a few feet the retroreflectors disappear visually to the at least one camera and still provide infrared tracking data so as to determine positional location of the camera.

Still another object of the present invention is to provide a LED volume constructed from a plurality of LED panels that provide an ability to allow filming of real time virtual environments and three dimensional tracking of at least one camera and eliminate post-production requirements wherein the integrated infrared tracking retroreflector can be embedded into the LED display panel as a small disk on the rear of the panel or on the front shader of the LED panel.

An additional object of the present invention is to provide a LED panel utilized to construct LED volumes wherein the LED panel is operable to provide positional tracking of at least one camera wherein the integrated infrared retroreflectors can further be integrated onto the pixel capsule, the enclosure that encapsulates the pixel wherein the pixel capsule can be coated with an infrared reflective chemical or material that is non-visible.

Yet a further object of the present invention is to provide a LED volume constructed from a plurality of LED panels that provide an ability to allow filming of real time virtual environments and three dimensional tracking of at least one camera and eliminate post-production requirements wherein the present invention employs an outside-in version of camera tracking achieved by embedding a plurality of infrared retroreflectors and/or a plurality of Lidar depth sensors into the LED panel in alternate locations to determine the camera position in space relative to the infrared retroreflectors and/or Lidar depth sensors.

Another object of the present invention is to provide a LED panel utilized to construct LED volumes wherein the LED panel is operable to provide positional tracking of at least one camera wherein the present invention provides discrete embedded tracking sensors in the LED panel so as to facilitate the process of capturing in-camera visual effects in an LED display in order to improve efficiency through substantial reduction of post production.

Still an additional object of the present invention is to provide a LED volume constructed from a plurality of LED panels that provide an ability to allow filming of real time virtual environments and three dimensional tracking of at least one camera and eliminate post-production requirements wherein the present invention provides a plurality of tracking sensors to collect depth and positional data for more accurate scanning and positional data of a camera and objects.

Yet another object of the present invention is to provide a LED panel utilized to construct LED volumes wherein the LED panel is operable to provide positional tracking of a plurality of cameras and objects disposed within the LED volume constructed with the LED panels of the present invention.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

FIG. 1 is an exploded rear view of an LED panel built in accordance with a retroreflector embodiment of the present disclosure.

FIG. 2 is a partial front view of pixel capsules and pixels in an LED panel built in accordance with an imaging embodiment of the present disclosure, showing the positioning of cameras in a cameras in black matrix/between LED packages framework.

FIG. 3 is a schematic showing the components of a combined pixel of an LED panel built in accordance with an imaging embodiment of the present disclosure, showing the positioning of cameras in a Coaxial LED+imager in a single package framework.

FIG. 4 is a partial side view of pixel capsules layer and a camera layer in an LED panel built in accordance with an imaging embodiment of the present disclosure, showing the behind the emitter frameworks.

### DETAILED DESCRIPTION OF THE INVENTION

Described herein, in an imaging embodiment of the present disclosure, is a display system which includes one or more LED panels, with each such panel having a display screen that includes an array of light-emitting pixels (e.g., LED, micro-LED, mini-LED, OLED, QD-LED) mounted on a substrate and an imaging subsystem operative to capture optical data from a scene in front of the display screen. The imaging subsystem may be optically and/or electrically integrated with the panel such that the surface of the LED panel simultaneously functions as both an emission surface and an aperture plane for image sensors of the imaging subsystem.

It is appreciated that the imaging subsystem of the LED panels may operate to capture optical data which can be used for used for eye tracking, viewing angle estimation, gaze mapping to screen coordinates, sentiment and pose estimation, object detection, SLAM/depth estimation, and so forth.

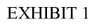

Referring now to the drawings and, in particular, FIG. 1, an LED panel 100 of a retroreflector embodiment of the present disclosure includes a housing 10 having an outer frame 12 manufactured from a suitable lightweight rigid material such as but not limited to plastic. The frame 12 includes cross members 14 wherein the cross members 14 are perpendicularly oriented between the opposing side members 16, 18. It should be understood within the scope of the present invention that the frame 12 could have varying quantities of cross members depending on the size of the frame 12. While the frame 12 is illustrated as being rectangular in shape herein, it should be understood within the scope of the present invention that the frame 12 could be provided in various shapes and sizes. Additionally, while one LED panel 100 is illustrated herein, it should be understood within a preferred embodiment of the present invention that the LED panel 100 is utilized to construct a LED volume for virtual filming wherein the LED volume is constructed of numerous LED panels 100 all be of the same construction as discussed herein for the LED panel 100. While not particularly illustrated herein, it should be understood within the scope of the present invention that operation of the LED panel 100 is executed through conventional computing devices.

Secured to the frame 12 utilizing suitable techniques is a display screen 20. The display screen 20 is disposed across the entire frame and is operable to provide display of desired images to be utilized in filming virtual environments. In its preferred embodiment the display screen 20 is a transparent LED screen. Secured to the rear surface, or proximate thereto, of the display screen 20 are a plurality of retroreflectors 30. The retroreflector 30 is operable to reflect light back to its source with minimal scattering. Furthermore, the retroreflector provides a wide range of angle of incidence. The plurality of retroreflectors are mounted to the display screen 20 providing coverage of all areas thereof. The retroreflectors 30 are utilized to provide tracking of an object such as but not limited to a camera that is proximate the LED panel 100. The retroreflectors 30 are located so as to inhibit the retroreflectors 30 from obscuring the pixels of the display screen 20. While the retroreflectors 30 in their preferred embodiment are small disk shaped as illustrated herein, it is contemplated that the retroreflectors 30 could be provided in alternate embodiments. By way of example but not limitation, the retroreflectors 30 could be provided so as to be mounted in an area between the pixels of the display screen 20 referred to as the front shader. Additionally, it is further contemplated within the scope of the present invention that the pixels of the display screen 20 could have a pixel capsule that is coated with an infrared reflective chemical so as to provide the desired function of providing light reflection for tracking of an object proximate to the display screen 20. It should be further understood within the scope of the present invention that the retroreflectors 30 could be provided in all of the aforementioned embodiments within a single LED panel 100. The retroreflectors 30 provide an ability to execute the aforementioned methodology of inside-out tracking of objects. Utilization of the retroreflectors 30 and the mounting location thereof improves the process of capturing in-camera visual effects in the screen display 20 as the final image in camera does not need post production in order to remove the retroreflectors 30 from the final image. Furthermore, deployment of a plurality of retroreflectors 30 provides an increase in available tracking data with no adverse effects.

The LED panel 100 further includes a plurality of lidar sensors 40. The lidar sensors 40 are secured around the perimeter of the frame 12. In a preferred embodiment, the lidar sensors 40 are secured to the side members 16, 18 as well as the upper cross member 7 and lower cross member 8. The lidar sensors 40 are conventional lidar sensors wherein the lidar sensors 40 are operable to provide light detection and ranging utilizing laser light to ping off objects so as to measure distance thereto and as such provide data for identifying the location of the pinged object. While the preferred embodiment of the LED panel 100 includes a plurality of lidar sensors 40 located on the perimeter of the frame 12, it should be understood within the scope of the present invention that as few as one lidar sensor 40 or a plurality of lidar sensors 40 could be employed. The lidar sensors 40 are employed to provide outside-in(as discussed previously herein) tracking of objects such as but not limited to a camera or prop.

The LED panel 100 further includes a plurality of optical sensors 50. The optical sensors 50 are secured to the frame 12 utilizing suitable techniques and are located on the upper cross member 7 and lower cross member 8. The optical sensors 50 in a preferred embodiment are optical triangulation position sensors operable to utilize reflected light waves to pinpoint position of an object. The optical sensor 50 projects light onto an object in the vicinity of the LED panel, such as but not limited to a camera, wherein the reflected light signal is utilized to determine position of the object. Utilization of the optical sensors 50 provides a technique to execute the aforementioned methodology of outside-in tracking of objects.

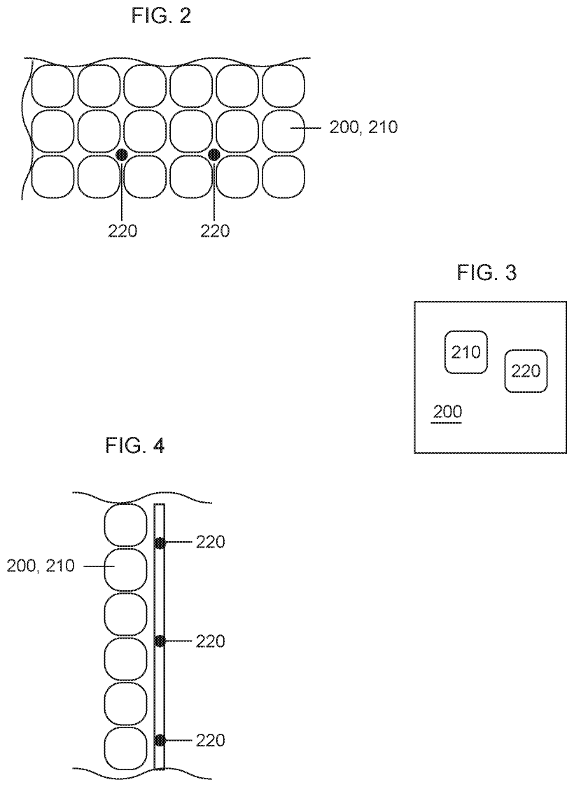

Referring now to FIGS. 2, 3 and 4, an LED panel of the imaging embodiment of the present disclosure may include a housing and display screen which are formed and constructed in the same manner as the housing and display screen from the retroreflector embodiment of the present disclosure, but may be built with or without the retroreflectors, lidar sensors, and optical sensors described in reference to the retroreflector embodiment. The display screen may include an array of light-emitting pixels 210 mounted on a substrate, with each of the pixels 210 enclosed in a pixel capsule 200. The imaging subsystem may be defined by one or a plurality of optical cameras 220 which may be optically and/or electrically integrated with the display screen. Advantageously, this allows objects that are positioned in front of the display screen, such that images present on the display screen may be visible from the position, are simultaneously able to be viewed by the optical cameras 220.

It is appreciated that the addition of optical cameras 220 to the display screen necessarily must be done in coordination with the placement of the pixels 210, and that this must be done in a manner which allows the display screen to remain suitable for its primary purpose, namely displaying images. Accordingly, in order to avoid compromising the display function of the display screen generally, and the pixels 210 which operate to provide the display functionality more specifically, the optical cameras 220 may be integrated with the display screen in one or more of the seven methods described below.

1. Interstitial front-surface micro-camera arrays (between pixels/“in the shader”). This approach may be implemented with a cameras in black matrix/between LED packages framework. Along these lines, tiny camera modules may be placed in the “dark” regions between LED packages so they're visually unobtrusive. This arrangement may be defined as follows:
Structure
   Display pixels with pitch (p) arranged on substrate.
   Interstitial regions (black matrix/mask) with width (p_{gap}).
   Micro-camera unit (e.g., CMOS sensor of 1-4 pixels or tiny array) placed in some of these gaps.
   Each micro-camera has:
      Protective cover glass flush with display surface.
      Micro-lens or lens stack (e.g., F/2-F/5) with focal length chosen so that focus range covers ~0.5-5 m in front of display.
      Cameras may be in a regular sub-grid, e.g. one camera per (M \times N) display pixels, or irregular patterns.
Optical details
   Field of view (FOV) chosen such that adjacent cameras'FOVs overlap for stitching into a wide-angle or near-panoramic view.
   Anti-reflection coatings and black mask around lens to minimize flare and visible artifacts in the emitted image.
   Pixel pitch of camera vs pitch of display calibrated for mapping between camera coordinate system and display pixel coordinates.
Electrical
   Camera readout synchronized with display scan (row/column drive) to avoid rolling-shutter artifacts from PWM.
   Cameras share a high-speed serial bus (MIPI CSI-2, LVDS, etc.) to a central processor running computer vision models.

This Interstitial front-surface micro-camera array approach may alternatively be implemented with a sub-pixel level micro-apertures with shared sensor framework. Along there would be no discrete lens per gap. Instead the following approach would be in place:
Small apertures (pinhole-like) in the black matrix.
Light from multiple apertures is guided to a shared image sensor via:
   Micro-lens array (MLA) acting as a plenoptic/light-field sensor.
   Optical waveguides or light pipes that route light down to a sensor underneath.
      In this approach, reconstruction uses computational imaging: each aperture location mapped to a region on the sensor; multiple apertures give multi-view sampling for depth / gaze estimation.

2. In-capsule coaxial camera+LED (camera “in the pixel”). This approach may be implemented with a Coaxial LED+imager in a single package framework. Along these lines, Each (or some) LED pixel is a composite opto-electronic package containing both emitters and an imager aligned along (approximately) the same optical axis. This arrangement may be defined as follows:
Package structure
   Substrate carries:
      One or more LED dies (R/G/B or white) arranged around a central axis.
      A central CMOS imager die (e.g., 8×8, 16×16, etc.).
   Above them:
      A beamsplitter or dichroic element.
      A microlens focusing incoming light onto the imager.
Optical multiplexing
   Wavelength domain: LED emits in visible range; imager sensitive primarily to NIR band. Front cover glass and dichroic filter pass NIR to sensor while reflecting/absorbing visible.
   Time domain: LED emission is PWM'd; during off-intervals, sensor integrates light. High-frequency duty cycling lets the same optical axis be used for illumination and imaging with minimal cross-talk.
Use cases
   High-density gaze tracking by mapping eye reflections across a distributed array of in-pixel cameras.
   Localized object detection close to specific regions of the display (e.g., user's hand gestures near certain UI elements).

This In-capsule coaxial camera+LED approach may alternatively be implemented with a 3D-stacked micro-LED on top of imaging CMOS framework. With this framework, there may be a Micro-LED display where each micro-LED is fabricated on top of a backplane that is itself a CMOS imager, along the following lines:
Stack
   Top: micro-LED array, pixel pitch (p_{LED}).
   Below: dielectric/interconnect layer.
   Bottom: CMOS imaging array (pixel pitch (p_{imager} \le p_{LED})).
Operation modes
   Display mode: CMOS works as standard drive backplane for micro-LEDs.
   Imaging mode: Micro-LEDs are driven to off or transparent state (or emit at a non-interfering wavelength); CMOS operates as imager capturing light through the micro-LED layer and front optical stack.
   Dual mode: Fast time multiplexing: micro-intervals for imaging interleaved with intervals for emission.
Optical challenges/solutions
   Micro-LED and encapsulation must allow sufficient transmission at the sensing wavelength (e.g., NIR).
   Pixel design may include transparent windows or lower-density emitter regions to increase transmission.
      This framework is close to the “reverse polarity pixel” concept but physically separated: one structure emits, the other senses, vertically stacked.

3. Behind-emitter through-aperture imaging (holes/vias in the LED plane”). This approach may be implemented with a Cameras located behind the LED PCB with dedicated apertures framework. Along these lines, sensors sit behind the LED layer and view the world through small holes in the LED plane. This arrangement may be defined as follows:
Structure
   Front: LED modules on PCB, with discrete packages.
   Between groups of LEDs, optical vias: holes in PCB and back plate aligned with small cover glasses at the front surface.
   Behind each via: camera module with lens located at some distance (d) from front surface.
Optics
   Each via forms an aperture; front cover glass is flush with display.
   Lens assembly behind stage defines FOV; lens can be recessed to handle thermal/mechanical tolerances.
   Aperture size chosen to balance resolution (diffraction limit), depth of field, and minimal disruption to panel uniformity.
Variants
   One camera per tile region: Each 32×32 or 64×64 LED tile has a central imaging aperture.
   Sparse array: Few larger cameras with wide FOV across the entire screen.

This Behind-emitter through-aperture imaging approach may alternatively be implemented with a Pinhole/coded aperture arrays framework. With this framework, the following characteristics are in place:
Multiple small apertures with no lens, each projecting a blurred pattern onto a shared sensor.
Use coded aperture imaging and deconvolution to reconstruct the scene.
   These characteristics are advantageous because that allow for a thinner package and less visible lens elements at the display surface.

4. Behind-emitter through-emitter imaging (transparent or dual-band LEDs). This approach may be implemented with an imaging through semi-transparent LED layers framework. Along these lines, sensors may sit behind the LED plane and “look through” the LED stacks and front diffuser, leveraging wavelength separation. This arrangement may include the following characteristics:
Optical stack
   Front protective glass/diffuser.
   LED encapsulant+LED dies emitting mostly in visible.
   Backplane substrate.
   Behind: imaging sensor plus lens.
Key trick
   Use NIR imaging: LED materials and diffusers can be engineered to be more transparent in NIR (e.g., 850-940 nm).
   Front surface may include NIR-pass/visible-block filter over specific regions aligned with cameras.
   LED drive pattern may be modulated to minimize interference at the sensing wavelengths.
Function
   Camera sees the scene through the emitting layer with some attenuation; the system is calibrated to correct for blur, distortion, and vignetting introduced by the LED/diffuser layer.

This Behind-emitter through-emitter imaging approach may alternatively be implemented with an index-matched light pipes between LED capsules for through-layer imaging framework. With this framework, the following characteristics are in place.
Embed small vertical light pipes (clear polymer rods or glass rods) that run from front surface down through the LED stack to an imaging sensor.
These pipes serve as optical channels with known refraction index; they can be arranged in a sparse grid.
Each pipe terminates on a microlens and sensor region; the rest of the display remains conventional.

5. Bidirectional LED pixels (reverse/alternative polarity sensing). This approach may be implemented using the concept of reverse polarity, with LEDs as photodiodes (time-multiplexed). Along these lines, many LED structures (p-n junctions) can operate as photodiodes when reverse-biased or even unbiased, generating photocurrent proportional to incident light. This arrangement may include the following characteristics:
Pixel Operation Modes
   Emission mode: Forward-bias LED to emit visible photons as usual.
   Sensing mode: Reverse-bias or zero-bias the junction, measure photocurrent, treat pixel as a crude imaging sensor.
   Drive is switched rapidly:
      For e.g., 240 Hz frame rate, use 200 Hz for emission, 40 Hz for sensing.
      Or alternate rows or columns between emission and sensing.
Per-pixel sensing
   Each display pixel outputs a sense value (or integrate regionally).
   Use these values to reconstruct a low-resolution image of the scene projected onto the display plane.
   Even limited dynamic range is enough for:
      Presence detection.
      Basic silhouette/motion detection.
      Gaze direction via corneal reflections and brightness variations.
Multi-wavelength approach
   LED emits visible; sensor is mainly responsive to NIR illumination from an NIR source mounted elsewhere (e.g., bezel).
   This creates a structured IR illumination field; LED pixels collect reflections.

This Bidirectional LED pixels approach may alternatively be implemented with a dedicated “dual-mode” pixels with separate emission and sensing sub-junctions framework. With this framework, instead of reusing the same p-n junction, each pixel may be fabricated with:
Emission sub-junction optimized for output at visible lin.
Sensing sub-junction optimized for photocurrent at NIR or broader band.
Both share the same physical footprint but have separate electrodes and biasing circuits.

It is appreciated that this framework gives stronger imaging performance while still counting as a “reversible” or bidirectional pixel in functional terms.

The Bidirectional LED pixels approach may also be implemented with region-of-interest sensing. With Region-of-interest sensing, only a subset of pixels (e.g., a sparse grid) operate in sensing mode to reduce cost and complexity; interpolation and ML models reconstruct full-field scene parameters (gaze, pose, etc.) from sparse sensing data.

6. Edge/perimeter cameras optically coupled into the panel. In this approach, cameras may not be strictly “inside each pixel,” but still may be embedded into the display assembly. Along these lines, a Bezel-mounted cameras with in-panel light redirection framework involving the following features may be implemented:
Cameras embedded in the bezel (top, bottom, left, right).
Prisms, light guides, or angled mirrors integrated into the front glass or diffuser redirect off-axis light from the viewer into these cameras.
From the viewer's perspective, the camera apertures appear within or very close to the active display region.

The Bidirectional LED pixels approach may alternatively be implemented with waveguide-based in-panel imaging, which may involve:
A planar waveguide layer just behind the front glass.
Light from the viewer enters the waveguide at the front surface (via micro-structures that couple light in).
Waveguide carries light laterally to sensors located at the panel edges.
Micro-structures can be arranged in a pixel-aligned or sub-pixel pattern; sensors reconstruct a wide FOV image from the pattern of coupled light.

7. Layered imaging backplane beneath emissive panel. This approach essentially provide for a display screen that is distributed over display two planes: an emissive front plane and an imaging backplane. Along these lines, there may be a separate imaging sensor plane behind LED modules, with the following characteristics:
Backplane is a relatively conventional imaging array (e.g., CMOS) that spans all or part of the panel area.
LED modules are mounted on a semi-transparent or perforated substrate above it.
Optical paths (apertures, holes, transparent regions) allow light to reach the backplane from the front.

It is contemplated that the backplane may be lower resolution than the display; the key is to get enough sampling density for computer vision tasks.

This layered imaging backplane beneath emissive panel approach may alternatively be implemented with a lenslet array+sensor plane framework. With this framework, a lenslet array may be aligned to the front surface, with each lens corresponding to a small group of display pixels. As a result, light is focused from the scene to a sensor plane at some distance; with each lens providing a small imaging patch. This is essentially an integral imaging/light-field sensor embedded behind the display.

It is contemplated that all of the above can be mixed with optical separation techniques, such as polarization, shutters, and filters. More specifically, the following techniques provide for various ways to modulate the optics:
Polarization-based emission/sensing separation
   Front polarizer aligned with emission; analyzers for sensing rotated relative to emission polarization.
   Cameras or sensing pixels are sensitive to one polarization state; emitted light to another, reducing interference.
Electrochromic or liquid crystal shutters over sensing regions
   At specific pixel locations, a small electro-optic shutter can switch between:
      Opaque/black (during display phases).
      Transparent (during sensing phases).
   This way the sensor can get high-contrast images when the shutter opens and LEDs are momentarily off or reduced.

It is further contemplated that the following combinations of approaches may be advantageously employed:
Macro+micro:
   Sparse array of high-resolution cameras behind panel (for coarse view/recognition) plus dense micro-sensors in or between pixels (for precise gaze/distance).
Static+steerable optics:
   Some cameras have MEMS mirrors or liquid lenses that steer FOV to regions with detected users.
Monocular+depth sensing:
   Combine standard imaging with time-of-flight (ToF) emitters integrated into the LED array or using LED pixels as modulated emitters for ToF, while cameras (or sensing pixels) read back phase/delay.

It is appreciated that beyond the mere integration of optical capturing units in the display screen (no matter which configuration is used), attention must be given to ensure sufficient calibration and data processing of the optical capturing units relative to the function of the screen. For example, it is contemplated that the following items must be address:
Geometric calibration:
   Mapping between each imaging element (camera pixel or sensing LED) and corresponding display pixels.
   Use homography/camera intrinsics+extrinsics.
Temporal synchronization:
   Synchronizing camera exposure windows with LED drive waveforms (PWM) to avoid flicker and blooming.
Multi-camera fusion:
   Stitching images from distributed micro-cameras into a single calibrated view.
Computer vision stack:
   Eye tracking: detect face, pupils, corneal reflections, infer gaze vectors relative to display plane.
   Viewing angle estimation: estimate 3D pose of viewer relative to display.
   Sentiment analysis: face detection, expression classification.
   Object detection: on viewers (phones, brand logos, gestures) and background scene.
   Depth estimation: via stereo (multi-camera), light field, or ToF modulation.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A LED panel utilized to construct a LED volume for filming simulated virtual environments wherein the LED panel, comprising:
a housing having a frame, wherein said frame defines a perimeter edge for said housing;
a display screen having a plurality of pixels disposed individually in a plurality of pixel capsules, wherein said display screen is mounted within said housing and being operable to display virtual images;
a plurality of optical cameras integral with said display screen, wherein each of said optical cameras is positioned between at least one adjacent pixel capsule which is among the plurality of pixel capsules; and
wherein the LED panel is operable to provide at least one technique of object tracking within the LED volume.

2. The LED panel of claim 1, wherein the plurality of optical cameras are utilized to provide said technique of object tracking.

3. The LED panel of claim 2, wherein said technique of object tracking employs an outside-in tracking methodology wherein the plurality of optical cameras are employed to track an object disposed within the LED volume.

4. A LED panel utilized to construct a LED volume for filming simulated virtual environments wherein the LED panel, comprising:
a housing having a frame, wherein said frame defines a perimeter edge for said housing;
a display screen having a plurality of pixels disposed individually in a plurality of pixel capsules, wherein said display screen is mounted within said housing and being operable to display virtual images;
a plurality of optical cameras integral with said display screen, wherein each of said optical cameras is integral with a dual pixel capsule which is among the plurality of pixel capsules; and
wherein the LED panel is operable to provide at least one technique of object tracking within the LED volume.

5. The LED panel of claim 4, wherein the plurality of optical cameras are utilized to provide said technique of object tracking.

6. The LED panel of claim 5, wherein said technique of object tracking employs an outside-in tracking methodology wherein the plurality of optical cameras are employed to track an object disposed within the LED volume.

7. A LED panel utilized to construct a LED volume for filming simulated virtual environments wherein the LED panel, comprising:
a housing having a frame, wherein said frame defines a perimeter edge for said housing;
a display screen having a plurality of pixels disposed individually in a plurality of pixel capsules, wherein said display screen is mounted within said housing and being operable to display virtual images;
a plurality of optical cameras integral with said display screen, wherein each of said optical cameras is positioned behind the plurality of pixel capsules; and
wherein the LED panel is operable to provide at least one technique of object tracking within the LED volume.

8. The LED panel of claim 7, wherein:
a plurality of transparent pixels amongst the plurality of pixels each include a transparent pixel portion and a plurality of transparent pixel capsules amongst the plurality of pixel capsules each include a transparent capsule portion; and
the optical cameras positioned on the display screen to be aligned with one of the transparent pixel portions and one of the transparent capsule portions.

9. The LED panel of claim 7, wherein:
the display screen includes a plurality of apertures in positions where there are none of the plurality of pixel capsules; and
each of the optical cameras positioned on the display screen to be aligned with one of the apertures.

10. The LED panel of claim 7, wherein the plurality of optical cameras are utilized to provide said technique of object tracking.

11. The LED panel of claim 10, wherein said technique of object tracking employs an outside-in tracking methodology wherein the plurality of optical cameras are employed to track an object disposed within the LED volume.
